(19) United States
(12) Patent Application Publication
(10) Pub. No.: US 2004/0227624 A1
(43) Pub. Date: Nov. 18, 2004

(54) System, apparatus and method for viewing information from a mobile station while driving

(76) Inventors: Philip Michael Hawkes, Burwood (AU); Gregory Gordon Rose, Concord (AU)

Correspondence Address: Qualcomm Incorporated, Patents Department, 5775 Morehouse Drive, San Diego, CA, 92121-1714, US

(21) Appl. No.: 10/718,983

(22) Filed: Nov. 20, 2003

Related U.S. Application Data
(60) Provisional application No. 60/428,536, filed on Nov. 22, 2002.

(51) Int. Cl. B60Q 1/00

(52) U.S. Cl. 340/425.5; 340/691.6; 345/905

(57) ABSTRACT

An apparatus and method for viewing information from a mobile station in a vehicle is disclosed. Generally, a display module is configured to be installed in a vehicle and to link with the mobile station to display information from the mobile station. A control module is coupled to the display module and configured to enable the display of the information from the mobile station.

### CROSS-REFERENCE TO RELATED APPLICATION

This application claims the benefit of U.S. Provisional Patent Application Serial No. 60/428,536 filed Nov. 22, 2002, which is incorporated herein by reference in their entirety.

### BACKGROUND OF THE INVENTION

### FIELD OF INVENTION

The invention generally relates to wireless communication and more particularly to wireless communication while driving.

### DESCRIPTION OF THE RELATED ART

Increasing availability of services through wireless communication technology has led to an increased use of mobile stations. For example, wireless communication systems may provide various types of information such as news, traffic conditions, stock quotes, maps, addresses, phones, email messages and other data. In many situations, users may wish to access such information while driving from one location to another location, especially during heavy traffic.

However, the use of a mobile station while driving may distract the driver and increase the chances for an accident. Particularly, when viewing information displayed on the mobile station, it is often difficult for drivers to maintain the attention needed for safe and/or defensive driving. Therefore, there is a need for allowing drivers to view information from mobile stations without comprising safety.

### SUMMARY

Embodiments disclosed herein address the above stated needs by providing a viewing apparatus that allows users to view information from a mobile station. In one aspect, an apparatus for viewing information from a mobile station in a vehicle, the apparatus comprising: a display module configured to be installed in the vehicle and link with the mobile station to display information from the mobile station; and a control module coupled to the display module and configured to enable the display of the information from the mobile station. The display module may be configured to be built into the vehicle on, for example, a windshield or a dashboard of the vehicle. Alternatively, the display module may be configured to be added onto the vehicle. Also, the display module may comprise a reflected display.

In another aspect, an apparatus for viewing information from a mobile station comprises a vehicle; a display module built into the vehicle, the display module configured to be linked with the mobile station and display information from the mobile station; and a control module coupled to the display module and configured to enable the display of the information from the mobile station. The vehicle may be an automobile, a motorcycle, a boat, a train or a plane. The display module may be built on a windshield or dashboard of the vehicle. Also, the display module may comprise a reflected display.

In a further aspect, a method for allowing users to view information from a mobile station in a vehicle comprises installing a display module, configured to be linked with the mobile station, in a vehicle; and enabling display of the information from the mobile station using the display module. Installing the display module may comprise installing the display module on a windshield of the vehicle or on a dashboard of the vehicle. Installing the display module may also comprise installing a reflected display as the display module. Moreover, installing the display module may comprise installing the display module in one of an automobile, a motorcycle, a boat, a train or a plane.

In still another aspect, an apparatus for allowing users to view information from a mobile station in a vehicle comprises means for installing a display module, configured to be linked with the mobile station, in the vehicle; and means for enabling display of the information from the mobile station using the display module. The means for installing the display module may comprise means for installing the display module on a windshield of the vehicle or on a dashboard of the vehicle. The means for installing the display module may also comprise means for installing a reflected display as the display module. Moreover, the means for installing the display module may comprise means for installing the display module in one of an automobile, a motorcycle, a boat, a train or a plane.

### BRIEF DESCRIPTION OF THE DRAWINGS

Various embodiments will be described in detail with reference to the following drawings in which like reference numerals refer to like elements, wherein:

FIG. 1 shows an example system for allowing users to view information from a mobile phone in a vehicle;

FIG. 2 shows an example wireless communication system;

FIG. 3 shows an example apparatus for viewing information from a mobile phone in vehicle; and

FIG. 4 shows an example method for allowing users to view information from a mobile phone in a vehicle.

### DETAILED DESCRIPTION

Embodiments below allow users to receive information from a mobile station while driving without compromising safety. In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, as disclosed herein, the term storage medium may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

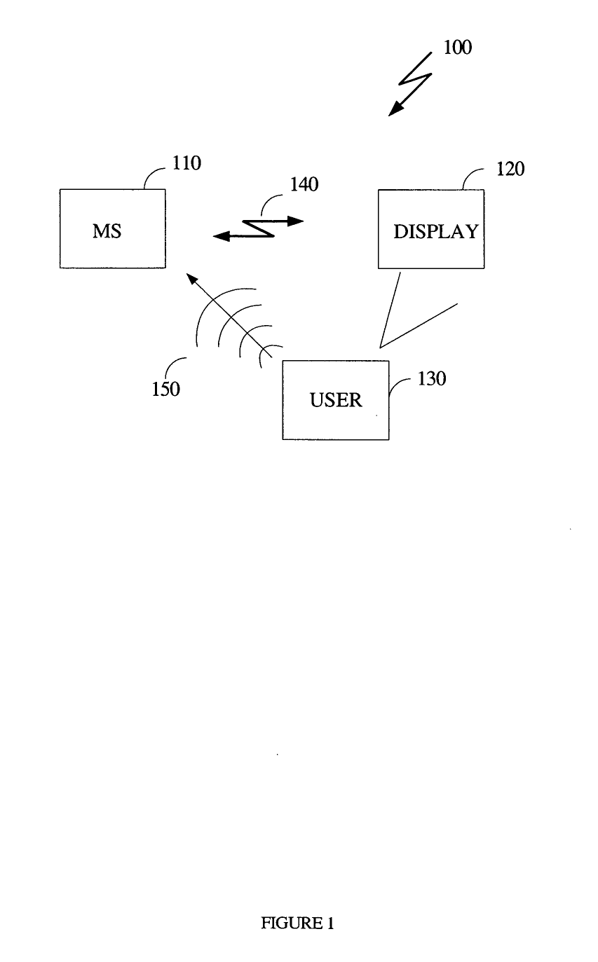

Generally, a display is used for viewing data or information from a mobile station. FIG. 1 shows an example system 100 for allowing users to receive information from a mobile station. System 100 comprises a driver 130 and a mobile station 110 linked to a display 120 installed or implemented in a vehicle. To view information from a mobile station, driver 130 may give instructions 150 to mobile station 110 based upon voice recognition. Alternatively, controls may be implemented in a location where driver 130 may easily access. For example, controls may be located on the steering wheel.

Display 120 is positioned such that driver 130 is not tempted to look at the mobile station while driving, thereby providing safety. More specifically, display 120 is implemented in a location where driver 130 may view display 120 without compromising safety. In some embodiments, display 120 may be implemented as a direct view. For example, in an automobile, display 120 may be positioned at the top, side or bottom of the windshield or windscreen so that driver 130 can see display 120 in the edge of her/his vision.

Display 120 may also be positioned at other places such as around the dashboard, the sun visor, the center console, the steering wheel, or as part of the rear-view mirror. In alternative embodiments, display 120 may be implemented in the form of special glasses worn by driver 130 that puts visual output at the edge of the field of vision. In still some embodiments, display 220 may be implemented as a reflected display. For example, display 120 may be positioned so that the driver views information in a reflection off either the windshield/windscreen, the rear-view mirror, a special see-through screen, or a special glasses or headwear. Here, any known technique can be used to provide a reflected display.

One such technique is the head-up display or sometimes referred to as heads-up display, which is well known and will not be discussed.

Furthermore, information from the mobile station may be, but is not limited to, short message service (SMS) message, phone numbers, addresses and maps. For example, the SMS messages may inform drivers of traffic problems and hazards. It also may allow driver 130 to use Wireless Application Protocol (WAP), a global standard for developing applications over wireless communication networks, while driving to perform operations such as booking tickets. Accordingly, driver 130 may view information received by the mobile station through a wireless communication system.

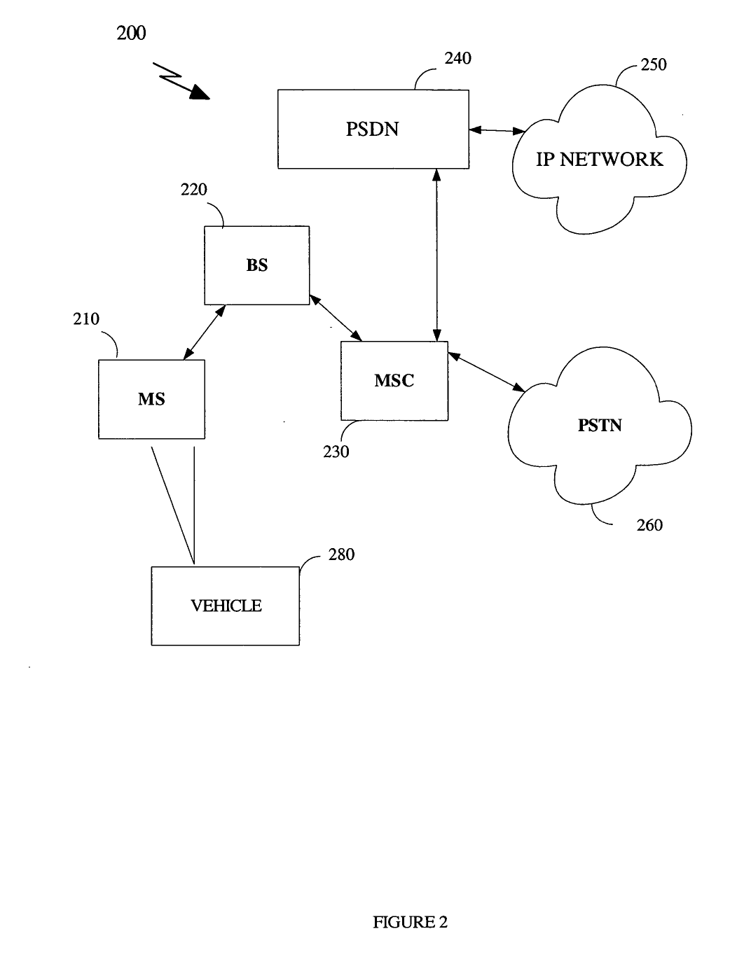

FIG. 2 show one example of a simplified wireless communication system 200 comprising a mobile station (MS) 210, sometimes referred to as subscriber unit or user equipment, that may be used in a vehicle 280. Here, MS 210 may be one of many remote stations that can be hand-held or portable and used in vehicle 280. Examples of MS 210 includes, but is not limited to, a mobile phone, personal data assistant (PDA) or a combination thereof. In addition, although vehicle 180 is shown to be a car, vehicle 280 represents other vehicles such as, but is not limited to, automobiles (trucks, cars and mobile homes), motorcycles, boats, trains and planes.

Wireless communication system 200 also comprises a base station (BS) 220; and a mobile switching center (MSC) or switch 230. Depending upon the configuration, system 100 may further include a packet data serving node (PDSN) or internetworking function (IWF) 240 and an Internet Protocol (IP) network 250, and/or a public switched telephone network (PSTN) 260. System 200 may be based on code division multiple access (CDMA), time division multiple access (TDMA), or other modulation techniques or a combination thereof. Also, it would be understood by those skilled in the art that there could be any number of transmitter devices, receiving devices, MSs, BSs, MSCs and PDSNs. Similarly, various configurations and operations of MS 210, BS 220, MSC 230, PSTN 260, PDSN 240 and IP network 250 are well known in the art and will not be discussed.

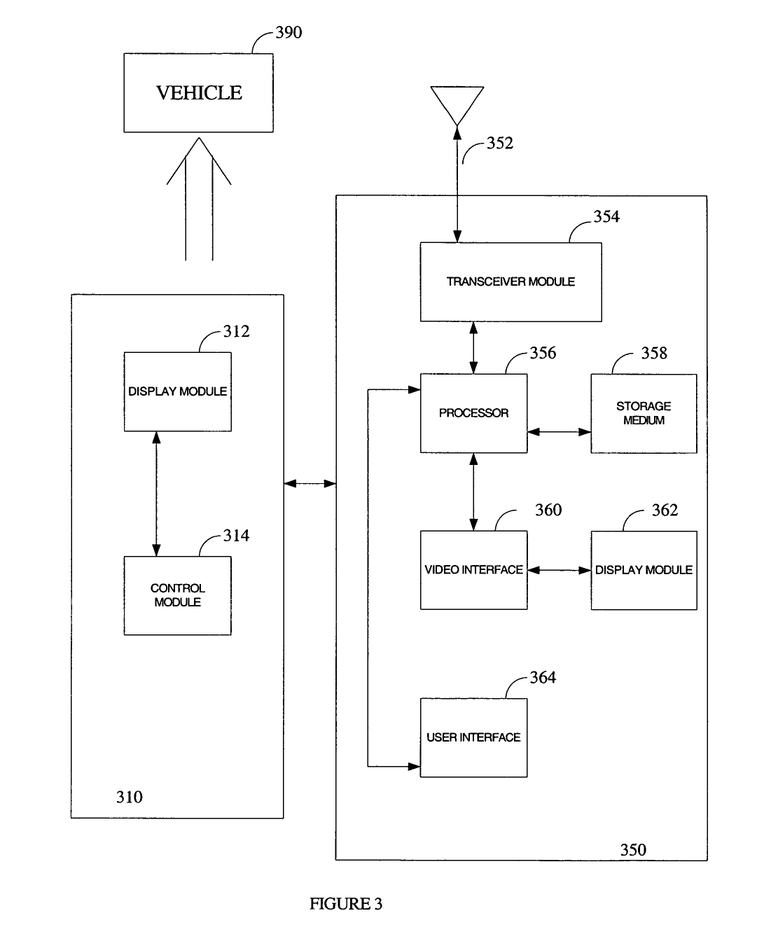

Therefore, drivers may view information stored in the mobile station or view information received by the mobile station through a wireless communication system. More particularly, FIG. 3 shows example viewing apparatus 310 that allows users, such as a driver, to view information from a mobile station while in a vehicle. Apparatus 310 comprises a display module 312 to be installed in a vehicle 390 and to be linked with a mobile station 350 using a link 330. Here, viewing apparatus 310 may be any known display unit as long as it is configured to be installed in a vehicle and to be linked with mobile station 350. In some cases, vehicle 390 should be configured to allow installation of viewing apparatus 310. Similarly, in some cases, mobile station 350 should be configured to allow data to be sent to viewing apparatus 312 using link 330.

Apparatus 310 also comprises a control module 314 that controls display module 312 to enable the display of information from mobile station 350. Control module 314 may be implemented using, for example, a processor, a microprocessor, a digital processor. Control module 314 may also be implemented together with display module 312 or may be implemented outside of viewing apparatus 310. For example, many vehicles include a processor, such as a central processing unit, that controls the electronic devices and/or features implemented in the vehicle. Such processor may be used for control module 314.

Display module 312 module may be a simple text-only display or a complex display capable of graphics. Display module 312 may be built into the vehicle, for example during manufacture, or be added later onto a manufactured vehicle. As described above, display module 312 may be a direct view or reflected display.

Mobile station 350 may comprise an antenna 352, a transceiver module 354, a processor 356, a storage medium 358, a video interface 360 a display module 362 and user interface 364. To transmit or receive data, a user may input commands or requests, hereinafter referred to as instructions, through user interface 364. Here, user interface 364 may comprise any known input device such as a keypad, a keyboard or a touch screen panel. Such input device may be implemented separately from, but configured to connect with mobile station 350. For example, an input device may be implemented on the steering wheel of a vehicle and can be connected to mobile station 350 to input instructions. Alternatively, the input device may be a voice-recognition input unit that allows users to verbally input instructions.

If the instruction is to view data stored in storage medium 358, information would be retrieved from storage medium 358 and processed by video interface 360 to be displayed on display module 362. If the instruction is to view data from a wireless communication system, the instruction would be processed and prepared by transceiver module 354 and communicated to the wireless communication system through antenna 352, under the control of processor 356. Also under the control of processor 356, data may then be received from the wireless communication system through antenna 352, may be stored in storage medium 358, and processed by transceiver module 354 and video interface 360 to be displayed on display module 362.

Typically, data would be displayed on display module 362. However, when mobile station 350 is linked with viewing apparatus 310, the data that is sent to display module 362 is sent from mobile station 350 to viewing apparatus by link 330. Here, link 330 may be non-wireless or a wireless connection. For example, a non-wireless connection may be implemented by one or more wires, tubes, twisted wires, cables, coaxial cables or fiber optic cables. Alternatively, a wireless connection may be implemented using Bluetooth, a short-range networking protocol for wireless connection of different types of devices.

The data received by viewing apparatus 310 is displayed as information on display module 312, under the control of control module 314. Here, display module 312 may be implemented using a technique that is analogous to the implementation of display module 362. Therefore, display module 312 can display data that is meant for display on display module 362. Alternatively, a video interface (not shown) may be implemented in viewing apparatus 310 to process data received from mobile station 350 in a display format required by display module 312. Also, information may also be displayed on display module 362 of mobile station 350 as well as display module 312 of viewing apparatus 310. In some embodiments, users may be provided with an option to display the information on both display modules 312 and 362, or only on display module 312. In addition, users may be provided with an option to activate and/or deactivate viewing apparatus 310. In such cases, data may only be sent from mobile station 350 to viewing apparatus 310, if the viewing apparatus 310 is activated.

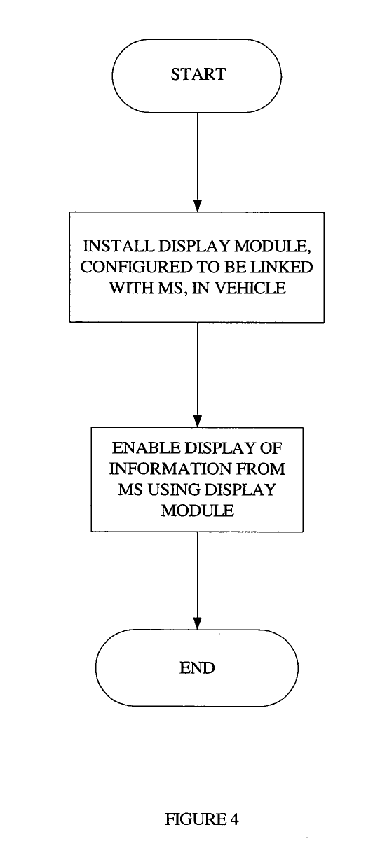

Therefore, users are allowed to view information from a mobile station, more safely, while driving. More particularly, FIG. 4 shows an example method 400 for allowing users to view information from a mobile station in a vehicle. In method 400, a display module that is configured to be linked with a mobile station is installed (410) in a vehicle. The display of information from a mobile station is then enabled (420) using a display module. Here, the display module may be display module 312 and the display of information may be enabled by control module 314, as described above.

Accordingly, by displaying information from a mobile station on a display positioned such that a driver is not tempted to look at the mobile station while driving, a safer viewing system is provided. Note that while the embodiments have been described with reference to drivers, the scope is not limited to persons actually driver. System 100 may be applicable to a passengers as well as the driver. Also, driver need not be driving for system 100 to be applicable. In addition, a more commercial viewing apparatus 310 may comprise other elements such as, for example, a user interface. Similarly, a more commercial mobile station 352 may comprise other elements such as, for example, an audio input/output. Furthermore, it should be apparent to those skilled in the art that the elements of mobile station 350 may be rearranged without affecting the operation of the viewing apparatus 310.

Therefore, the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. Apparatus for viewing information from a mobile station in a vehicle, the apparatus comprising:
a display module configured to be installed in the vehicle and link with the mobile station to display information from the mobile station; and
a control module coupled to the display module and configured to enable the display of the information from the mobile station.

2. The apparatus of claim 1, wherein the display module is configured to be built into the vehicle.

3. The apparatus of claim 2, wherein the display module is configured to be built on a windshield of the vehicle.

4. The apparatus of claim 2, wherein the display module is configured to be built on a dashboard of the vehicle.

5. The apparatus of claim 1, wherein the display module is configured to be added onto the vehicle.

6. The apparatus of claim 1, wherein the display module comprises a reflected display.

7. Apparatus for viewing information from a mobile station comprising:
a vehicle;
a display module built into the vehicle, the display module configured to be linked with the mobile station and display information from the mobile station; and
a control module coupled to the display module and configured to enable the display of the information from the mobile station.

8. The apparatus of claim 7, wherein the vehicle is one an automobile, a motorcycle, a boat, a train or a plane.

9. The apparatus of claim 7, wherein the display module is built on a windshield of the vehicle.

10. The apparatus of claim 7, wherein the display module is built on a dashboard of the vehicle.

11. The apparatus of claim 7, wherein the display module comprises a reflected display.

12. A method for allowing users to view information from a mobile station in a vehicle, the method comprising:
installing a display module, configured to be linked with the mobile station, in a vehicle; and
enabling display of the information from the mobile station using the display module.

13. The method of claim 12, wherein installing the display module comprises:
installing the display module on a windshield of the vehicle.

14. The method of claim 12, wherein installing the display module comprises:
installing the display module on a dashboard of the vehicle.

15. The method of claim 12, wherein installing the display module comprises:
installing a reflected display as the display module.

16. The method of claim 12, wherein installing the display module comprises:
installing the display module in one of an automobile, a motorcycle, a boat, a train or a plane.

17. Apparatus for allowing users to view information from a mobile station in a vehicle, the apparatus comprising:
means for installing a display module, configured to be linked with the mobile station, in the vehicle; and
means for enabling display of the information from the mobile station using the display module.

18. The apparatus of claim 17, wherein installing the display module comprises:
means for installing the display module on a windshield of the vehicle.

19. The apparatus of claim 17, wherein installing the display module comprises:
means for installing the display module on a dashboard of the vehicle.

20. The apparatus of claim 17, wherein installing the display module comprises:
means for installing a reflected display as the display module.
